(19) United States
(12) Patent Application Publication
(10) Pub. No.: US 2025/0127339 A1
(43) Pub. Date: Apr. 24, 2025

(54) IMMERSIVE BATHTUB

(71) Applicant: Kohler Co., Kohler, WI (US)

(72) Inventors: Dongha Lee, Sheboygan, WI (US); Hiroyuki Muraoka, Milwaukee, WI (US)

(21) Appl. No.: 18/905,380

(22) Filed: Oct. 3, 2024

Related U.S. Application Data
(60) Provisional application No. 63/591,876, filed on Oct. 20, 2023.

(51) Int. Cl. A47K 3/12; A47K 3/00; A47K 3/28

(52) U.S. Cl. CPC A47K 3/122; A47K 3/001; A47K 3/281

(57) ABSTRACT

A bathtub system includes a bathtub housing, a pedestal configured to support the bathtub housing, a rotatable seat assembly mounted to the bathtub housing, the rotatable seat assembly including a headrest, and sprayers mounted to the bathtub housing. At least one of the plurality of sprayers is at a position above the headrest of the seat assembly. In addition, the bathtub system may include a projector configured to project an image on a surface of water, at least one sensor configured to detect a user input with respect to the image on the surface of the water, and a controller configured to generate an output in response to the detected user input.

### CROSS-REFERENCE TO RELATED APPLICATIONS

This application claims priority benefit of Provisional Application No. 63/591,876 (Docket No. 010222-23025B-US) filed on Oct. 20, 2023, which are hereby incorporated by reference in its entirety.

### FIELD

The present application relates generally to the field of bathtubs.

### BACKGROUND

A bathtub is a container for holding water in which a human or other animal bathes. Bathtubs generally rest on four-legs or are mounted into a supporting structure (e.g., the wall or the floor). Bathtubs are generally rigid and do not move. Bathtubs generally have a water spout and/or showerhead that supplies water to the bathtub. However, relieving these constraints may provide advantages over existing bathtubs.

### BRIEF DESCRIPTION OF THE DRAWINGS

Exemplary embodiments are described herein with reference to the following drawings, according to an exemplary embodiment.

FIG. 1 illustrates an example inclined bathtub.

FIG. 2 illustrates an example set of sprayers for the inclined bathtub.

FIG. 3 illustrates an example external tank for the inclined bathtub.

FIG. 4 illustrates an example internal tank for the inclined bathtub.

FIG. 5 illustrates an example distributed intelligent bathtub.

FIG. 6 illustrates another view of the distributed intelligent bathtub of FIG. 5.

FIG. 7 illustrates a control system for the distributed intelligent bathtub of FIG. 5.

FIG. 8 illustrates another example controller for any of the foregoing embodiments.

FIG. 9 illustrates a method for operation of the controller of FIG. 8 for an inclined bathtub.

FIG. 10 illustrates a method for operation of the controller of FIG. 8 for a bathtub projection system.

### DETAILED DESCRIPTION

The following embodiments include one or more novel features of a bathtub using a bathtub control system. In certain embodiments, structure is provided that enables the bathtub to pivot about one or more points in space and provide various angles of inclination (e.g., row, tilt, yaw) for the user resting in the bathtub. One or more sensations may also be provided to the user in the bathtub (e.g., vibration, scent, temperature, jets, visual). One visual sensation may include a projection made onto the bathtub or water contained by the bathtub. The projection may depict one or more lifelike images that are coordinated with other sensations in the bathtub. A sensor may detect the user's interaction with the projection or detect other movement or gestures of the user to provide commands to the bathtub control system.

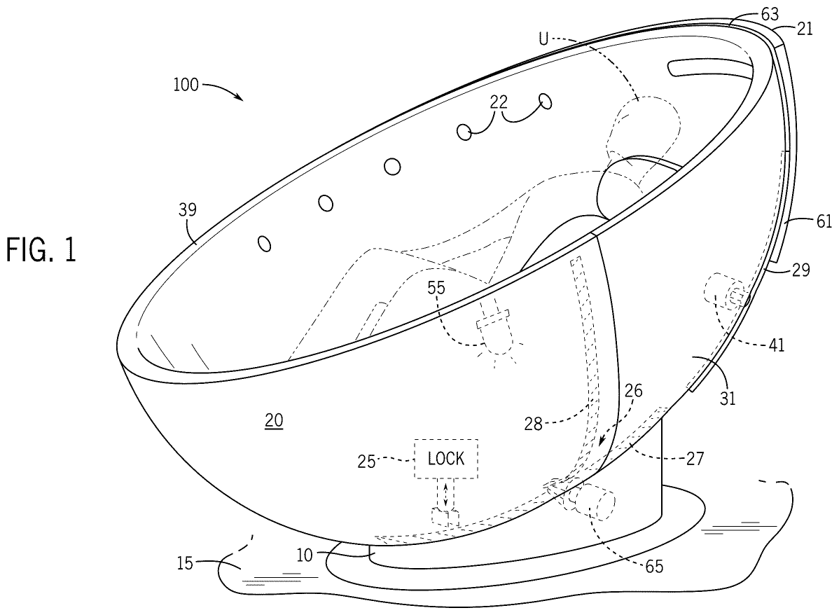

FIG. 1 illustrates an example inclined bathtub 20. The bathtub 20 may include at least a pedestal 10, a cover 21, and one or more sprayers 22. Additional, different, or fewer components may be included.

The sprayers 22 are mounted along the rim of the bathtub 20. The sprayers 22 may be interconnected by one or more hoses. For example, a network of hoses connected by diverter valves may be selectively provide with water in a variety of patterns to engage a subset of the sprayers 22. The bathtub 20 may be formed of a bathtub housing, which may support a vitreous material forming an enclosure that holds water in the bathtub 20. While jets may be included, the sprayers 22 are not jets. The sprayers 22 are not intended to operate submerged in water. Rather, the sprayers 22 spray the user with water as the bathtub 20 is filling with water. The sprayers 22 may be mounted above a median line halfway between a bottom and a top of the bathtub 20. The sprayers 22 may be mounted above a line indicative of half of the volume of the bathtub 20.

Pedestal 10 is configured to support the bathtub housing. The pedestal 10 may be mounted to the floor 15. In some examples, plumbing (e.g., a water supply line, a water drain line) may be provided through the pedestal 10 to the bathtub 20. The pedestal 10 may include a drive track 26 so that the bathtub 20 is movable (e.g., rotatable) with respect to the pedestal 10. In one example, the drive track 26 may include one or more bearings between the pedestal 10 and the bathtub 20. The bathtub 20 may be manually rotated by applying a force (e.g., from the user to the bathtub 20).

A locking device 25 may lock the pedestal 10 and the bathtub 20 in a locked position. For example, the user may move the bathtub 20 along the drive track 26 of the pedestal 10 and then secure the bathtub 20 at a predetermined position. The predetermined position may be defined by an angle of the bathtub 20 with respect to the floor 15. The locking device 25 may include a détente. The locking device 25 may include a bolt or pin that is mated with an opening on the drive track 26. The user may grip the locking device 25 to push the bolt or pin into engagement with the drive track 26 to prevent the bathtub 20 from movement with respect to the pedestal 10. In another example, a solenoid or other electrically powered device is a bolt or pin that is electronically placed into and out of engagement with the drive track 26 to prevent the bathtub 20 from movement with respect to the pedestal 10. The solenoid or other electrically powered device may be operated in response to command signals from the controller 101 described below.

A drive mechanism 65 is configured to rotate the bathtub housing with respect to the pedestal 10. The drive mechanism 65 may include a motor configured to actuate, at least in part, a drive portion to rotate the bathtub housing with respect to the pedestal 10 along the drive track 26. The drive mechanism 65 may include one or more paths or axes. In one example, a single path provides an arc for rotating and translating the position of the bathtub housing. In another example, the drive mechanism 65 may include multiples axes (e.g., roll, pitch, yaw) used to select a specific orientation for the bathtub. For example, the drive track 26 may include a substantially horizontally arced segment or path 27 and a substantially vertically arced segment or path 28.

The bathtub 20 may be defined by a closed portion 31 (or bathtub housing) to enclose water and an opening 39 around the rim of the bathtub 20. The user enters the bathtub 20 through the opening 39. The cover 21 is configured to selectively cover at least part of the opening 39. The cover 21 may slide with respect to the bathtub 20, for example, along a cover track 29. The cover track 29 may be parallel to the outer surface of the bathtub housing. The cover 21 may include at least one wheel or other device that rides along the cover track 29. The cover 21 may be moved to at least partially cover the opening 39.

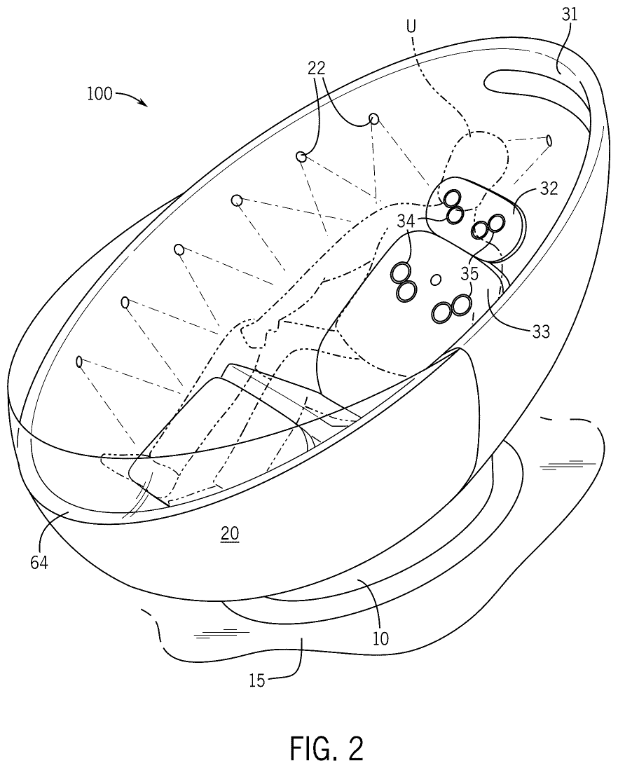

The cover 21 may include multiple sections. For example, the cover 21 may include top section 61 (FIG. 1) and bottom section 64 (FIG. 2). The bottom section 64 is a first portion configured to retract with respect to a front side of the bathtub housing, and the top section 61 is a second portion configured to retract with respect to a rear side of the bathtub housing.

A cover drive motor 41 is configured to selectively retract and extend the cover with respect to a rear side of the bathtub housing. The cover drive motor 41 may rotate a gear that messes with the track for the cover 21.

The cover 21 may include or otherwise support a screen 63. The screen 62 may be inside the cover 21 facing the user as the user lays in the bathtub 20. The screen 62 may include a liquid crystal display (LCD) or another type of display configured to present images and alphanumeric characters to the user. The screen 62 may be curved. The curvature of the screen 62 may be selected so the screen 62 is parallel to the bathtub housing.

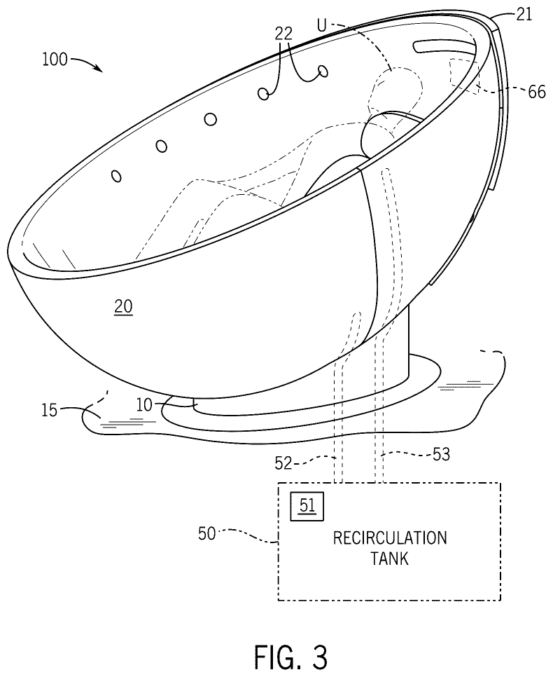

A controller (e.g., controller 101 described herein) may select the images and alphanumeric characters displayed to the user via the screen 62. A user input may be integrated with the screen 62 or otherwise electrically coupled to the controller and external to the screen 62 (e.g., as shown by control panel 66 in FIG. 3). The alphanumeric characters may relate to the operation of the bathtub 20. The alphanumeric characters may include a valve setting or temperate of the supply lines to the bathtub 20. alphanumeric characters may include settings for sound, vibration, scent, jets, or other features.

The bathtub 20 may include one or more exterior light 55 configured to illuminate an environment of the bathtub system according to a position of the cover 21. When the cover 21 is controlled to be open, the exterior light 55 is illuminated. When the cover 21 is controlled to be closed, the exterior light 55 is not illuminated (e.g., turned off).

The exterior light 55 may include a light emitting diode (LED) or another type of light. The exterior light 55 may include a pattern of multiple lights. Individual lights in the pattern may include indicators for various settings or features of the bathtub 20 including sound, vibration, scent, jets, or other features.

FIG. 2 illustrates another embodiment for the inclined bathtub 20 including a seat assembly 32 mounted to the bathtub housing. The seat assembly 32 may be rotatable with respect to the bathtub housing. The seat assembly 32 may include a headrest 32. The inclined bathtub 20 includes sprayers 22 mounted to the bathtub housing such that at least one of the sprayers 22 is at a position above the headrest 33 of the seat assembly 32.

The seat assembly 32 may also include at least one sensory device. The at least one sensory device may be mounded in the headrest 33 or back portion of the seat assembly 32. An example sensory device may include one or more speakers 34 configured to provide sound from audio signals provided by the controller. An example sensory device may include one or more vibratory emitters 35 configured to provide vibrations from control signals provided by the controller. An example sensory device may include one or more scent emitters configured to release vapor or mist including particles designated with a predetermined scent based on control signals provided by the controller (e.g., controller 101 described herein) for the sensory device.

FIG. 3 illustrates an example external tank 50 for the inclined bathtub 20. The tank 50 may be a recirculation tank 50 that collects water from the bathtub 20 and re-delivers the water to the bathtub 20 via sprayers 22. The recirculation tank 50 may be concealed below the floor 15. The recirculation tank 50 may be integrated with the inclined bathtub 20. One or more pipes or tubes may connect the sprayer 22 to the tank 50. For example, a drain pipe 52 is configured to drain water from the bathtub 20 at a first (low) height. A recirculation pipe 53 is configured to deliver water back to the sprayers 22 through a sprayer supply line. The tank 50 may include, or otherwise be connected to, a pump 51 for provided the flow of water from the tank 50 to the sprayers 22.

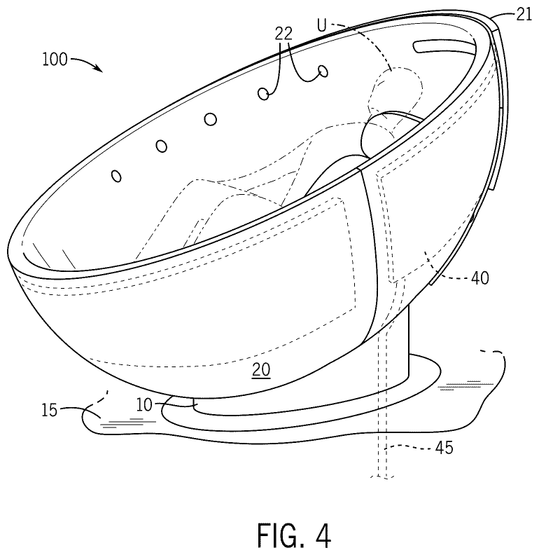

FIG. 4 illustrates an example internal tank or chamber 40 for the inclined bathtub 20. The chamber 40 may be coupled to the pedestal 10 and configured to hold water. In some instances, the chamber 40 is a pre-chamber filled by water supply 45 before the water reaches the bathtub 20 and sprayers 22. In other instances, the chamber 40 is part of a recirculation network in which water is collected from the bathtub 20 and returned to the bathtub 20 at a later time.

The chamber 40 may operate as part of the drive mechanism for rotation of the bathtub 20 with respect to the pedestal 10. For example, as the chamber 40 fills with water, the chamber 40 places a force on the bathtub 20 to rotate the bathtub 20 with respect to the pedestal 10. In one example, the bathtub 20 (as well as the seat assembly 32) is at an upright angle (e.g., having a vertical component) when the chamber 40 is empty or substantially empty. As the chamber 40 fills, a force (e.g., having a vertical component) is placed on the bathtub 20, causing the bathtub 20 to move along a predetermined path and rotate with respect to the pedestal 10.

The user may place the chamber 40 is a predetermined position (e.g., predetermined angle) in order to set the desired inclination angle of the bathtub 20. In this way, the chamber 40 fills with water as a function of an inclination angle of the bathtub housing.

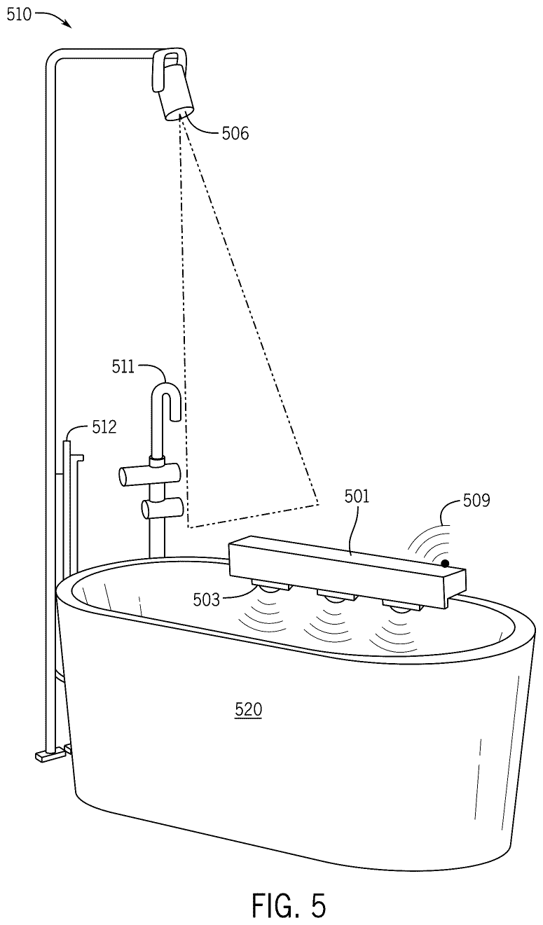

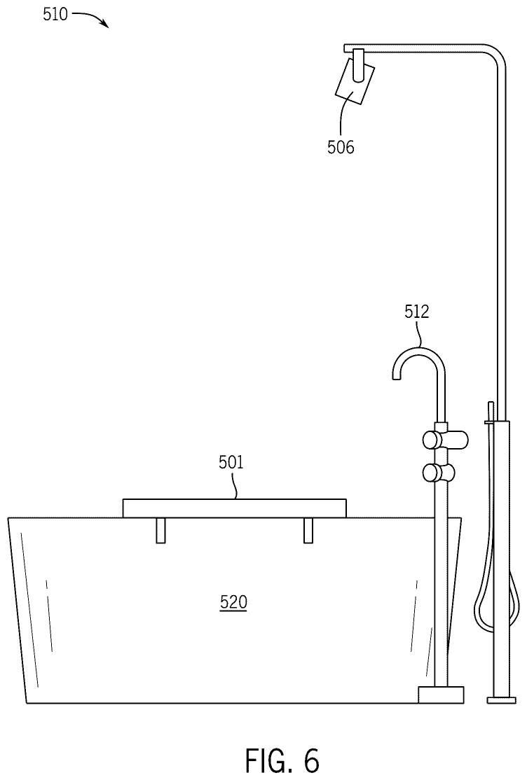

FIG. 5 illustrates an example distributed intelligent bathtub system 510. The distributed intelligent bathtub system 510 includes at least a projector 506 and a control shelf 501 mounted with respect to a bathtub 520. The control shelf 501 and the projector 506 communicate wirelessly (e.g., Bluetooth, Wi-Fi, etc.) through a radio, antenna, or other communication interface 509. The control shelf 501 includes a mounting support configured to couple the shelf to the bathtub. The mounting support may include a grip that is tightened against the bathtub 520. In addition, a faucet 511 and a spray wand 512 may be mounted with respect to the bathtub 520 and/or the distributed intelligent bathtub system 510. Additional, different, or fewer components may be included. FIG. 6 illustrates another view of the distributed intelligent bathtub of FIG. 5.

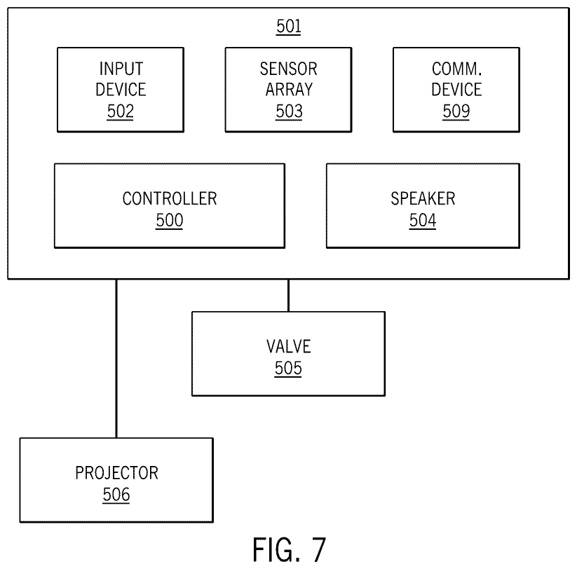

FIG. 7 illustrates a block diagram for the distributed intelligent bathtub system 510 of FIG. 5. The control shelf 501 includes a controller 500, an input device 502, a sensor array 503, a communication device 509, and a speaker 504. Additional, different, or fewer components may be included.

The projector 506 configured to project an image on a surface of water in the bathtub 520. The image may include lifelike images associated with water. Example images may include fish, lily pads, insects, waves or other objects. The user may interact with the images according to the following examples.

The sensor array 503 includes at least one sensor in sensory array 503 configured to detect a user input with respect to the image on the surface of water in the bathtub 520. The sensor may include a camera (e.g., image sensor) that captures one or more images (e.g., video) of the surface of the water and the user. The images may also include the projection from projector 506 on the surface of the water. The controller 500 is configured to generate an output in response to the detected user input through a comparison of the relative position of the user and the projection.

The sensor may include a time of flight sensor configured to measure the gesture of the user using distance measurements. The controller 500 is configured to use the known position of the projected images relative to the bathtub 520 and the detected gestures from the user to render new images to be projected on the water by the projector 506. The controller 500 may include a graphics processor to render the graphics and images. The graphics processor may run Java script and output to the projector via high definition multimedia interface (HDMI). The controller 500 may include a renderer (Java script) device that computes the data from the to determine the graphics and interactions for output via the projector onto the water surface.

The controller 500 is configured to evaluate the relative positions of the user and objects in the projections to generate subsequent projections and simulate an interaction between the user and the projections. For example, when the projection is a fish. The user may place a hand in the way of the fish. The controller 500 generates a new frame depicting the path of the fish to swim around the user's hand.

The controller 500 is configured to evaluate the relative positions of the user and objects in the projections to generate subsequent projections and cause a selection for the bathtub system 510 based on the interaction between the user and the projections. For example, the projection may be a user input depicting a temperature of the water in the bath. The projection may include an indicator for HOT and an indicator for COLD. When the user points at the HOT indicator, or splashes in proximity to the HOT indicator, or gestures toward the HOT indicator, the controller 500 generates a valve command for a valve 505 (e.g., mixer 511) to mix in or release more hot water into the bathtub 510. When the user points at the COLD indicator, or splashes in proximity to the COLD indicator, or gestures toward the COLD indicator, the controller 500 generates a valve command for a valve 505 (e.g., mixer 511) to mix in or release more cold water into the bathtub 510.

In another example, the sensor captures user inputs for a speaker selection. The speaker selection could be a volume or a music selection. The speaker 504 may be configured to generate sound associated with the projected image on the surface of water in the bathtub 520. Sound associated with the projected image could be the splash of swimming fish or the croak of a from sitting on a lily pad. The projection image may include an indicator for VOLUME UP or VOLUME DOWN.

When the user points at the VOLUME UP indicator, or splashes in proximity to the VOLUME UP indicator, or gestures toward the VOLUME UP indicator, the controller 500 generates a speaker command to turn up the volume of the speaker 504. When the user points at the VOLUME DOWN indicator, or splashes in proximity to the VOLUME DOWN indicator, or gestures toward the VOLUME DOWN indicator, the controller 500 generates a speaker command to turn up the volume of the speaker 504. When the user points at or otherwise indicates the change in music selection, the controller 500 generates a music selection command to select a different music selection from a streaming surface or music library in memory.

A vibratory device is configured to provide vibrations felt by the user. When the user points at the VIBRATION indicator, or splashes in proximity to the VIBRATION indicator, or gestures toward the VIBRATION indicator, the controller 500 generates a vibration command to activate vibration. Similarly, the controller 500 may provide intensity controls for the vibratory device. The vibratory device is configured to generate vibration associated with the image on the surface of water in the bathtub 520.

A heater is configured to heat water in a tank associated with the bathtub 520, heat water in a supply line for the bathtub 510, or heat water contained in the bathtub 520. When the user points at a HEAT indicator, or splashes in proximity to the HEAT indicator, or gestures toward the HEAT indicator, the controller 500 generates a heat command to activate the heater. Similarly, the controller 500 may provide intensity controls for the heater. The heater is configured to generate heat associated with the image on the surface of water in the bathtub 520.

A scent device configured to generate scent in proximity of the bathtub 520. The scent device may include a diffuser, an atomizer, or a mister that emits particles into the ambient air. The particles may be adhered to water droplets. The particles may be selected from a selection of types of particles each associated with a different smell. An indicator for the scent device may be associated with activation of the scent device or selection of a particular scent. When the user points at a SCENT indicator, or splashes in proximity to the SCENT indicator, or gestures toward the SCENT indicator, the controller 500 generates a scent command to activate the scent device.

A pump may be configured to generate a pressurized flow of water to one or more water supplies for the bathtub 520. An example water supply is a submerged jet. An example water supply is one or more sprayer 22. When the user points at a JET or SPRAYER indicator, or splashes in proximity to the JET or SPRAYER indicator, or gestures toward the JET or SPRAYER indicator, the controller 500 generates a water supply command to activate the water supply. Alternatively, the controller 500 may control the water supply in association with the image on the surface of water in the bathtub 520.

Various commands may be coordinated by the controller 500. For example, the bathtub 520 may simulate a rain shower by activating the sound of rain through speaker 504, the feel of raining through the vibration device, the feel of rain through sprayers 22, and the image of rain projected by projector 506.

A communication device (e.g., communication interface 353) may receive a template or other downloaded data from a mobile device (e.g., laptop, mobile phone) through a network connection (e.g., wireless) to define the images projected onto the surface of the water. In some examples, the mobile device also operates a sensor to detect the image on the surface of water in the bathtub and provide the image to the controller 500. A memory may store the downloaded data, template for the projected image, or indicator used for the setting.

The input device 502 may include an input interface configured to receive an interface input from the user. The input device 502 may include a touchscreen or keypad. The input device 502 may be used to specify the setting that is adjustable using the image projected on the water. At least one setting for the bathtub 520 is based on the interface input from the input device 502 and the detected user input from the at least one sensor on the surface of the water.

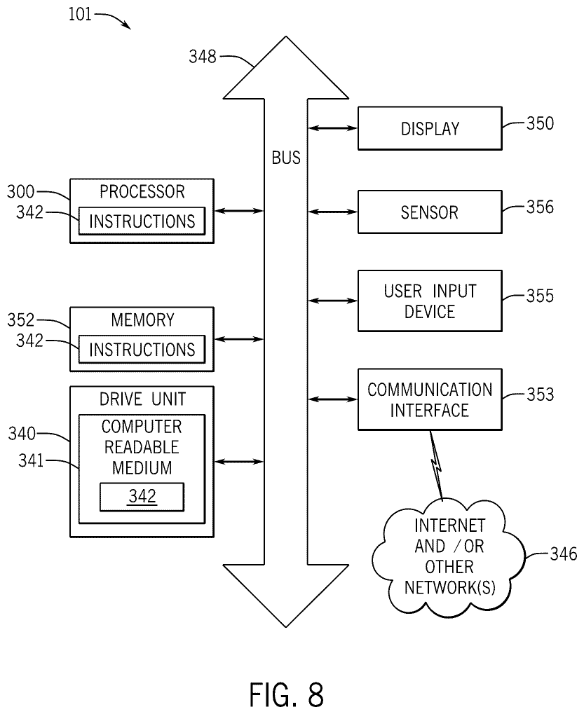

FIG. 8 illustrates an example embodiment for a controller 101 for the inclined bathtub and/or the distributed bathtub projected described herein. The controller 101 may include a processor 300, a memory 352, and a communication interface 353 for interfacing with devices or to the internet and/or other networks 346. The controller 101 and communication interface 353 may each or both include an internal memory. The memory 352 represents internal memory to processor 300 or external memory in the alternative or in combination. Likewise, the communication interface 353 may include internal memory.

In addition to the communication interface 353, a sensor interface 356 may be configured to receive data from the sensors described herein or data from any source for detecting the presence of a user, the position of a user, or gestures from the user. The components of the control system 101 may communicate using bus 348. The control system 160 may be connected to a workstation or another external device (e.g., control panel) and/or a database for receiving user inputs, system characteristics, and any of the values described herein.

The input device 355 may include a switch (e.g., actuator), a touchscreen coupled to or integrated with, a keyboard, a remote, a microphone for voice inputs, a camera for gesture inputs, and/or another mechanism. The input device 355 may be implemented using the projected image and feedback system described herein.

Optionally, the control system 160 may include a drive unit 340 for receiving and reading non-transitory computer media 341 having instructions 342. Additional, different, or fewer components may be included. The processor 300 is configured to perform instructions 342 stored in memory 352 for executing the algorithms described herein. A display 350 may be supported by any of the components described herein. The display 350 may be combined with the user input device 355.

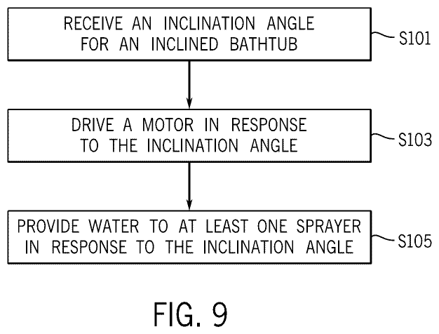

FIG. 9 illustrates an example flow chart for the controller of FIG. 8 for controlling an inclined bathtub. Additional, different, or fewer acts may be included.

At act S101, the processor 300 receives data indicative of an inclination angle for the inclined bathtub. The inclination angle may be received as input from the user (e.g., selected from a screen or keypad). The inclination angle may be received as part of a user setting (e.g., personalized angle selection or part of a bathing sequence).

At act S103, the processor 300 drives a motor in response to the inclination angle. The motor may be a stepper motor and include a position that corresponds to the inclination angle. The processor 300 may receive feedback from an angle sensor and select commands for the motor to target the angle.

At act S105, the processor 300 may operate a valve to provide water to the bathtub in response to the inclination angle. In one example, water is provided through one or more sprayers after the inclination angle is reached. In another example, water is provided through the sprayers as the bathtub is rotating to the desired inclination angle.

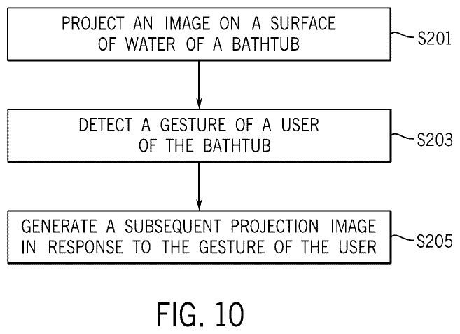

FIG. 10 illustrates an example flow chart for the controller of FIG. 8 for controlling a bathtub using projected images. Additional, different, or fewer acts may be included.

At act S201, the processor 300 sends image data to a projector so that one or more images are projected on the surface of the water of the bathtub. The projected images may include one or more settings for the bathtub. Example settings include water temperature, fill level, sound settings, scent settings, light settings or other examples.

At act S203, the processor 300 receives sensor data indicative of a gesture of the user. A sensor such as a proximity sensor, position sensor, time of flight sensor or other example detects a position of the user with respect to the projected image. The use may interact with the projected image (e.g., simulate pressing a button that is projected on the surface of the water). In some examples, a camera detects the relative position of the user.

At act S205, the processor 300 generates a subsequent image in response to the gesture of the user. For example, when the original projected image includes a button, the subsequent image may show the button depressed or another color. Similarly, the subsequent image may show a status bar or tick mark indicative of the selection being made.

Processor 300 may be a general purpose or specific purpose processor, an application specific integrated circuit (ASIC), one or more programmable logic controllers (PLCs), one or more field programmable gate arrays (FPGAs), a group of processing components, or other suitable processing components. Processor 300 is configured to execute computer code or instructions stored in memory 352 or received from other computer readable media (e.g., embedded flash memory, local hard disk storage, local ROM, network storage, a remote server, etc.). The processor 300 may be a single device or combinations of devices, such as associated with a network, distributed processing, or cloud computing.

Memory 352 may include one or more devices (e.g., memory units, memory devices, storage devices, etc.) for storing data and/or computer code for completing and/or facilitating the various processes described in the present disclosure. Memory 352 may include random access memory (RAM), read-only memory (ROM), hard drive storage, temporary storage, non-volatile memory, flash memory, optical memory, or any other suitable memory for storing software objects and/or computer instructions. Memory 352 may include database components, object code components, script components, or any other type of information structure for supporting the various activities and information structures described in the present disclosure. Memory 352 may be communicably connected to processor 300 via a processing circuit and may include computer code for executing (e.g., by processor 300) one or more processes described herein. For example, memory 298 may include graphics, web pages, HTML files, XML files, script code, shower configuration files, or other resources for use in generating graphical user interfaces for display and/or for use in interpreting user interface inputs to make command, control, or communication decisions.

In addition to ingress ports and egress ports, the communication interface 353 may include any operable connection. An operable connection may be one in which signals, physical communications, and/or logical communications may be sent and/or received. An operable connection may include a physical interface, an electrical interface, and/or a data interface. The communication interface 353 may be connected to a network. The network may include wired networks (e.g., Ethernet), wireless networks, or combinations thereof. The wireless network may be a cellular telephone network, an 802.11, 802.16, 802.20, or WiMax network, a Bluetooth pairing of devices, or a Bluetooth mesh network. Further, the network may be a public network, such as the Internet, a private network, such as an intranet, or combinations thereof, and may utilize a variety of networking protocols now available or later developed including, but not limited to TCP/IP based networking protocols.

While the computer-readable medium (e.g., memory 352) is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. The computer-readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A bathtub system comprising:
a bathtub housing;
a pedestal configured to support the bathtub housing;
a rotatable seat assembly mounted to the bathtub housing, the rotatable seat assembly including a headrest; and
a plurality of sprayers mounted to the bathtub housing, wherein at least one of the plurality of sprayers is at a position above the headrest of the seat assembly.

2. The bathtub system of claim 1, further comprising:
a drive mechanism configured to rotate the bathtub housing with respect to the pedestal.

3. The bathtub system of claim 2, further comprising:
a chamber coupled to the pedestal and configured to hold water, wherein a weight of the chamber actuates, at least in part, the drive mechanism.

4. The bathtub system of claim 3, wherein the chamber fills with water as a function of an inclination angle of the bathtub housing.

5. The bathtub system of claim 2, further comprising:
a motor configured to actuate, at least in part, the drive mechanism.

6. The bathtub system of claim 2, wherein the bathtub housing includes a closed portion to enclose water and an opening.

7. The bathtub system of claim 6, further comprising:
a cover configured to selectively cover at least part of the opening.

8. The bathtub system of claim 7, wherein the cover includes a first portion configured to retract with respect to a front side of the bathtub housing and a second portion configured to retract with respect to a rear side of the bathtub housing.

9. The bathtub system of claim 7, further comprising:
a screen coupled to the cover.

10. The bathtub system of claim 9, wherein the screen is curved.

11. The bathtub system of claim 7, further comprising:
a cover drive motor configured to selectively retract and extend the cover with respect to a rear side of the bathtub housing.

12. The bathtub system of claim 7, further comprising:
a screen coupled to the cover; and
a controller configured to provide images to the screen.

13. The bathtub system of claim 7, further comprising:
an exterior light configured to illuminate an environment of the bathtub system according to a position of the cover.

14. The bathtub system of claim 1, further comprising:
a lock configured to secure the pedestal and the bathtub housing at a predetermined position.

15. The bathtub system of claim 1, wherein the plurality of sprayers are the only fill device for the bathtub system.

16. The bathtub system of claim 1, further comprising:
a projector configured to project an image on a surface of water;
at least one sensor configured to detect a user input with respect to the image on the surface of the water; and
a controller configured to generate an output in response to the detected user input.

17. A projection system for a bathtub, the projection system comprising:
a projector configured to project an image on a surface of water in the bathtub;
at least one sensor configured to detect a user input with respect to the image on the surface of water in the bathtub; and
a controller configured to generate an output in response to the detected user input.

18. The projection system of claim 17, further comprising:
a shelf including a mounting support configured to couple the shelf to the bathtub, wherein the shelf includes the at least one sensor and the controller.

19. The projection system of claim 17, further comprising:
an input interface configured to receive an interface input from the user, wherein at least one setting for the bathtub is based on the interface input and the detected user input from the at least one sensor.

20. The projection system of claim 17, further comprising at least one of:
a speaker configured to generate sound associated with the image on the surface of water in the bathtub;
a vibratory device configured to generate vibration associated with the image on the surface of water in the bathtub;
at least one valve configured to adjust a flow of water based on the output from the controller;
a heater configured to generate heat associated with the image on the surface of water in the bathtub;
a scent device configured to generate scent associated with the image on the surface of water in the bathtub; and
at least one jet configured to generate a pressurized flow of water associated with the image on the surface of water in the bathtub.
